(19) United States
(12) Patent Application Publication
(10) Pub. No.: US 2026/0040409 A1
(43) Pub. Date: Feb. 5, 2026

(54) Modulating Electrical Resistance along a Column of E-Bricks

(71) Applicant: Electrified Thermal Solutions, Inc., Medford, MA (US)

(72) Inventors: Munevver Elif Asar Sarikaya, Newton, MA (US); Joey Kabel, Arlington, MA (US); Dan McKinley, Cambridge, MA (US); Kwadwo Sarpong, Everett, MA (US); Donald Smith, Medford, MA (US); Daniel Stack, Malden, MA (US); Bao Truong, Canton, MA (US)

(21) Appl. No.: 19/287,283

(22) Filed: Jul. 31, 2025

Related U.S. Application Data
(60) Provisional application No. 63/677,824, filed on Jul. 31, 2024.

(51) Int. Cl. H05B 3/14; H05B 3/00; H05B 3/06; H05B 3/24

(52) U.S. Cl. CPC H05B 3/141; H05B 3/0004; H05B 3/06; H05B 3/24; H05B 2203/016

(57) ABSTRACT

A column of electrically conductive metal oxide material, the column comprising a first end; a second end; a body extending between the first end and the second end; a first volume proximate the first end of the body; and a second volume proximate the second end of the body. The first volume has a greater average cross-sectional area of electrically conductive metal oxide material, normal to a longitudinal axis of the body, than the second volume.

### CROSS-REFERENCE TO RELATED APPLICATIONS

This application claims the benefit of U.S. Provisional Application No. 63/677,824, filed Jul. 31, 2024, the disclosure of which is hereby incorporated by reference in its entirety.

This application incorporates by reference, in their entireties, each of the following related and commonly owned non-provisional applications filed on even date herewith and having the following titles: Gas Turbine with an Electrically Heated Thermal Energy Storage System, U.S. application Ser. No. 18/790,901; Chromium Electrodes to Deliver Electric Power to Oxide Brick Circuits, U.S. application Ser. No. 18/791,024; Ceramic-Metal Composites for Use as Heating Elements for Electrified Resistance Heating and Thermal Energy Storage Systems, U.S. application Ser. No. 18/790,995; and Electrically Conductive Brickwork Module for Use as a Heating and/or Thermal Storage System, U.S. application Ser. No. 18/790,819.

This application also incorporates by reference, in its entirety, the following provisional patent application filed on even date herewith and having the following title: Bent Pipe-Shaped Electrically Conductive Cross Brick Design, U.S. Provisional Application No. 63/677,894.

### TECHNICAL FIELD

The present invention relates to modulating electrical resistance along a column of E-Bricks (or firebricks) and more particularly to modulating electrical resistance along a column of E-Bricks such that there is a temperature zoning along the column.

### BACKGROUND ART

Traditional firebricks are a type of brick designed to insulate heat and withstand high temperatures, with common applications including lining furnaces, kilns, and chimneys. Electrically conductive firebrick systems combine this traditional heat-withstanding quality with electrical conductivity to enable thermal heating and storage solutions capable of reaching temperatures in the 1000° C. to 2000C or higher and reliably cycling between a predetermined temperature range (e.g. ^{˜}1000° C. to ^{˜}1800° C.) on a daily basis without requiring the burning of fossil fuels. In such systems air/gas may be flowed through the firebrick system to extract the heat for various uses, including for use in industrial processes.

One such firebrick system is described in U.S. Pat. No. 11,877,376. In the disclosed firebrick system, air/gas flows straight over the conductive bricks. In the case of chromium oxide bricks, which may be used in this system, it has been found that the chromium oxide volatilizes, which erodes the brick's electrical performance over time, and also produces a toxic gas (CrO3) that must be kept below regulated levels and as low as possible.

U.S. Publication No. 2025/0052516 discloses an electrically conductive brickwork module configured to be used in an electrically heated thermal energy storage system and/or a resistive heating system to heat a fluid flowing across a dimension of the electrically conductive brickwork module from an input to an output. The module includes a plurality of electrically interconnected sets of electrically conductive bricks (E-Bricks) configured to be heated when electricity flows there through and a plurality of electrically insulating bricks separating each pair of adjacent sets of the plurality of electrically interconnected sets.

### SUMMARY OF THE EMBODIMENTS

In accordance with one aspect, the disclosure provides a column of electrically conductive metal oxide material, the column comprising: a first end; a second end; a body extending between the first end and the second end; a first volume proximate the first end of the body; and a second volume proximate the second end of the body; wherein the first volume has a greater average cross-sectional area of electrically conductive metal oxide material, normal to a longitudinal axis of the body, than the second volume.

2. In some aspects, the comprises a plurality of electrically conductive metal oxide bricks (E-Bricks), the first volume comprises one or more E-Bricks and the second volume comprises one or more E-Bricks.

In some aspects, the plurality E-Bricks are vertically stacked and the first end is at a top of the body and the second end is at a bottom of the body; and wherein each E-Brick has a volume of electrically conductive metal oxide material and each E-Brick comprises a first end, a second end, and a length between the first and second ends.

In some aspects, the E-Bricks proximate the top of the body have a greater average cross-sectional area of electrically conductive metal oxide material than the E-Bricks proximate the bottom of the body. At least one of the E-Bricks in the body may contain a hollow cavity between the first and second ends of the E-Brick.

In some aspects, each of the plurality of E-Bricks in the body has the same cross-sectional area and wherein one or more E-Bricks proximate the bottom of the body have a hollow cavity between the first and second ends of the E-Bricks and one or more E-Bricks proximate the top of the body have a uniform amount of electrically conductive metal oxide material dispersed throughout the length of the E-Bricks.

In some aspects, each of the plurality of E-Bricks in the body has a uniform amount of electrically conductive metal oxide dispersed throughout the volume of the E-Brick and wherein one or more E-Bricks proximate the bottom of the body have a first cross-sectional area and one or more E-Bricks proximate the top of the body have a second cross-sectional area, the first cross-sectional area being smaller than the second cross-sectional area.

In some aspects, one of the plurality of E-Bricks may be a transitional E-Brick connected between the E-Bricks proximate the bottom of the body and the E-bricks proximate the top of the body and wherein the first end of the transitional E-Brick has a cross-sectional area equivalent to the first cross-sectional area and is in contact with one of the E-Brick proximate the bottom of the body and the second end of the transitional E-Brick has a cross-sectional area equivalent to the second cross-sectional area and is in contact with one of the E-Bricks proximate the top of the body.

The plurality of E-Bricks may be one of (i) cylindrical in shape, (ii) bow-tie shaped, or (iii) rectangular prism shaped.

In some aspects, each E-brick contains an interlocking feature on the first end and a complementary interlocking feature on the second end, and wherein the E-Bricks are interlocked along the body. The body may comprise a unitary structure of electrically conductive metal oxide material.

In some aspects, the first end is at a top of the body and the second end is at a bottom of the body, and wherein the first volume extends a first length from the top of the body toward the bottom of the body and the second volume extends a second length from proximate an end of the first volume to the bottom of the body. The body may include a hollow cavity extending along at least a portion of the second length of the second volume.

In some aspects, the body, including along the first length and the second length, has the same cross-sectional area and wherein portions of the body proximate the bottom include the hollow cavity.

In some aspects, the body, has a uniform dispersion of electrically conductive metal oxide, including throughout the first volume and the second volume; and wherein along the first length the body has a first cross-sectional area and along the second length the body has a second cross-sectional area, the first cross-sectional area being greater than the second cross-sectional area.

In some aspects, there is included a transitional section between first length and the second length and a first end of the transitional section has a cross-sectional area equivalent to the first cross-sectional and a second end of the transitional section has a cross-sectional area equivalent to the second cross-sectional area.

In some aspects, the body along the length is one of (i) cylindrical in shape, (ii) bow-tie shaped, or (iii) rectangular prism shaped.

### BRIEF DESCRIPTION OF THE DRAWINGS

The foregoing features of embodiments will be more readily understood by reference to the following detailed description, taken with reference to the accompanying drawings, in which:

FIG. 1 provides a perspective view of an exemplary E-TESS system according to an aspect of this disclosure.

FIG. 2 provides a cross-sectional view of the exemplary E-TESS system of FIG. 1.

FIG. 3 provides a perspective view of an exemplary electrically conductive brick of the E-TESS system according to an aspect of this disclosure.

FIG. 4 provides a perspective view of an exemplary electrically insulative brick of the E-TESS system according to an aspect of this disclosure.

FIG. 5 provides a cross-sectional view of an exemplary E-TESS system, according to an aspect of this disclosure, depicting a circuit of electrically conductive brick connected to input and output electrodes.

FIG. 6 shows an embodiment of a solid cylindrical E-Brick within a hollow core region of circular I-Brick, according to an aspect of this disclosure.

FIG. 7 shows perspective view of an embodiment of a double-cylinder I-Brick according to an aspect of this disclosure.

FIG. 8 shows perspective view of a cylindrical E-Brick according to an aspect of this disclosure.

FIG. 9 shows an embodiment of two columns of cylindrical E-Bricks, according to an aspect of this disclosure.

FIG. 10 shows a perspective view of a double-cylinder end connector, according to an aspect of this disclosure.

FIG. 11 shows a cross section (taken along the length/height) of a rectangular E-Brick having two vertically disposed hollow cavities that increase the electrical resistance of the E-Brick, according to an aspect of this disclosure.

FIG. 12 shows the E-Brick design of FIG. 11 stacked one on top of the other to form a stack or column of E-Bricks, according to an aspect of this disclosure.

FIG. 13 is an E-Brick cross section (taken along the length/height of a rectangular E-Brick) showing two horizontally disposed hollow cavities to increase the electrical resistance of the E-Brick compared to a solid rectangular E-Brick with the same dimensions, according to an aspect of this disclosure.

FIG. 14 shows the E-Brick design of FIG. 13 stacked one on top of the other to form a stack or column of E-Bricks, according to an aspect of this disclosure.

FIG. 15 is an E-Brick cross section (taken along the length/height of a rectangular E-Brick) showing a single, longer vertically disposed hollow cavity to increase the electrical resistance of the E-Brick compared to a solid rectangular E-Brick with the same dimensions, according to an aspect of this disclosure.

FIG. 16 shows the E-Brick design of FIG. 15 stacked one on top of the other to form a stack or column of E-Bricks, according to an aspect of this disclosure.

FIG. 17 shows an E-Brick design that may be stacked one on top of the other to form a stack or column of E-Bricks, according to an aspect of this disclosure.

FIG. 18 shows an additional embodiment of an E-Brick design that may be stacked one on top of the other to form a stack or column of E-Bricks, according to an aspect of this disclosure.

FIG. 19 shows yet another embodiment of an E-Brick design that may be stacked one on top of the other to form a stack or column of E-Bricks, according to an aspect of this disclosure.

FIG. 20 shows Bow Tie shaped E-Brick cross sections, according to an aspect of this disclosure.

FIG. 21 compares different E-Brick designs, visually, volumetrically and by volume ratio, according to an aspect of this disclosure.

FIG. 22 shows electric charging model results with Bow Tie 2 design, according to an aspect of this disclosure.

FIG. 23 shows a transition from the hot zone to the transition zone to the warm zone for a bow-tie design, according to an aspect of this disclosure.

FIG. 24A shows a column of cylindrically shaped E-Bricks having a greater/widening diameter towards the top of the column, according to an aspect of this disclosure.

FIG. 24B shows a cylindrical E-Brick, according to an aspect of this disclosure.

FIG. 24C shows cylindrical E-Brick having a smaller diamer than that of the E-Brick of FIG. 24B, according to an aspect of this disclosure.

FIG. 24D shows an E-Brick having a greater diameter at its top compared to its bottom, according to an aspect of this disclosure.

FIG. 24E shows a double-cylinder end firebrick connector (a “cross-brick”) that is configured to physically and electrically couple two columns of E-Bricks, according to an aspect of this disclosure.

### DETAILED DESCRIPTION OF SPECIFIC EMBODIMENTS

The disclosure and the various features and advantageous details thereof are explained more fully with reference to the non-limiting embodiments and examples that are described and/or illustrated in the accompanying drawings and detailed in the following description. Various aspects of the subject matter discussed in greater detail below may be implemented in numerous ways, as the subject matter is not limited to any particular manner of implementation. Examples of specific implementations and applications are provided primarily for illustrative purposes.

Unless otherwise defined, used, or characterized herein, terms that are used herein (including technical and scientific terms) are to be interpreted as having a meaning that is consistent with their accepted meaning in the context of the relevant art and are not to be interpreted in an idealized or overly formal sense unless expressly defined herein. The terminology used herein is for the purpose of describing particular embodiments and is not intended to be limiting of exemplary embodiments. As used herein, singular forms, such as “a” and “an,” are intended to include the plural forms as well, unless the context indicates otherwise. Additionally, the terms “includes,” “including,” “comprises,” and “comprising” specify the presence of the stated elements or steps but does not preclude the presence or additional of one or more other elements or steps.

Embodiments described herein may comprise, or make use of, electrically conductive (and thermally conductive) bricks (“E-bricks”). E-bricks generate heat when a current is run through them via direct resistance heating (DRH). E-bricks may be capable of reaching very high temperatures, such as 1000° C. to 2000° C. or higher and reliably cycling between a predetermined temperature range (e.g. ˜1000° C. to ˜1800° C.) on a daily basis. E-bricks may be stacked, e.g., into columns that are physically and electrically coupled, and arranged into a large structure, a thermal energy storage system (“TESS”) (a.k.a. an electrically heated thermal energy storage system E-TESS). Examples of E-bricks and E-TESS's may be found in U.S. Pat. No. 11,877,376, U.S. Publication No. US2025/0052516, and U.S. Publication No. 2025/0047225, the contents of each of which are hereby incorporated, in full, by reference. Embodiments of E-TESS's may be used, for example, in various industrial and chemical processes that generate and/or consume heat, such as furnaces, kilns, refineries, power plants, allowing these processes to significantly reduce or eliminate burning of fossil fuels.

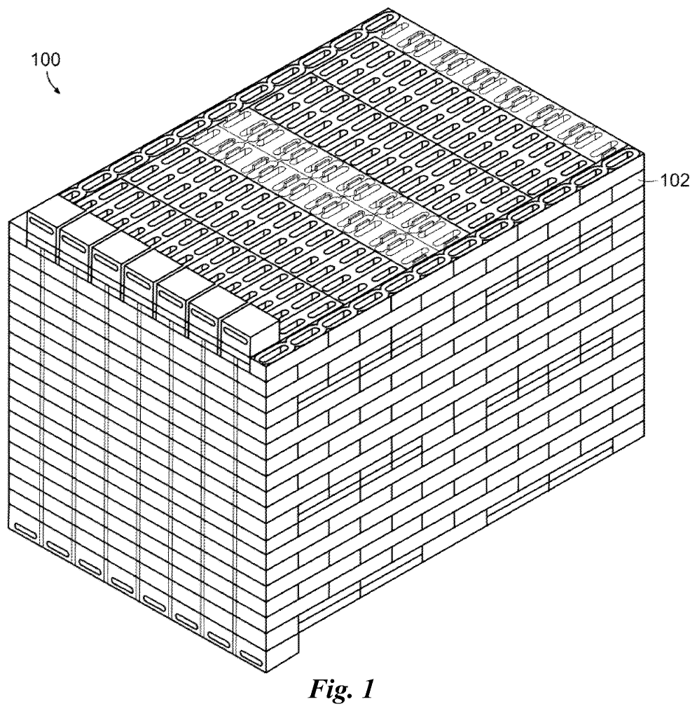

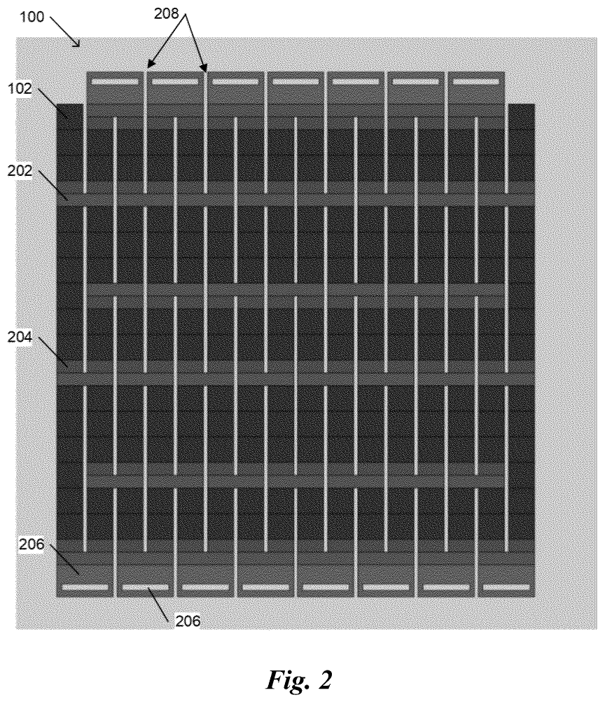

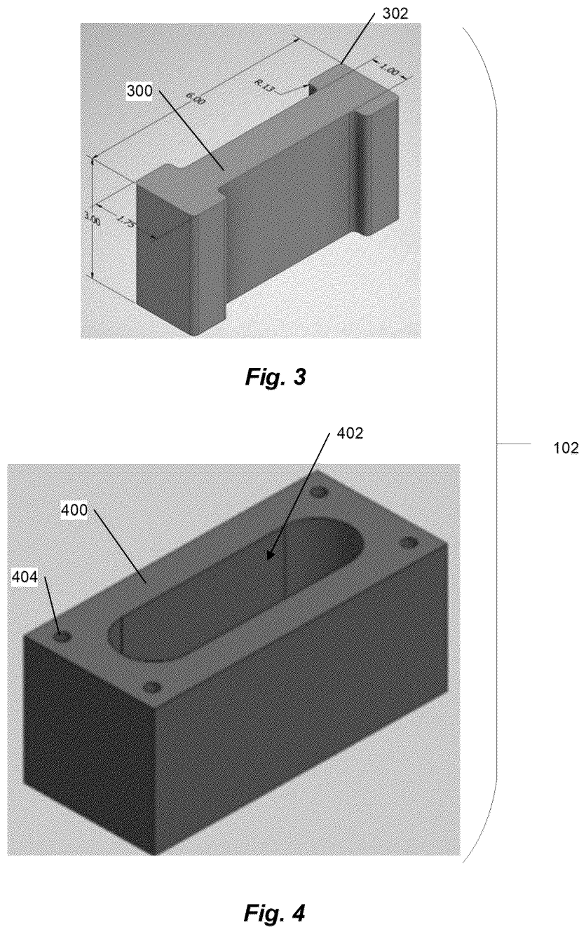

FIG. 1 shows an exemplary embodiment of an E-TESS module 100, which is primarily composed of a large quantity of electrically and thermally conductive brick assemblies 102 (“E-brick assemblies”). The E-brick assembly 102 may comprise an electrically conductive brick 300 (“E-brick”), FIG. 3, contained within an electrically insulating (but thermally conductive) brick 400 (“I-brick”), FIG. 4. In some embodiments there may be more than one E-brick contained within an I-brick, or there may be a plurality of I-bricks that, in combination, provide insulation to one or more E-bricks. In FIGS. 1 and 2, only the I-bricks of the E-brick assemblies 102 are visible, as the E-bricks are contained in an internal region within the I-brick as shown in FIG. 4 and described below. The E-bricks in each column are physically in contact with each other and physically connected to the E-bricks in adjacent columns to form one contiguous electrical circuit when a voltage is applied across the E-TESS module 100, thereby causing an electric current to flow through the electrical circuit formed by the E-bricks.

The E-TESS module 100 generates a large amount of thermal energy when an electrical current is run through the contiguous circuit of E-bricks. The thermal energy may be stored in the E-bricks/I-bricks for extended periods of time (e.g., up to 24 hours). The thermal energy may be harvested immediately, or after it has been stored, by flowing a fluid, e.g., a gas, such as air or CO₂, through E-TESS module 100. The thermal energy in the E-bricks is transferred to the I-bricks and flow paths or channels (shown in FIG. 2) between the columns of E-brick assemblies 102 allow the fluid to flow through the E-TESS module 100. This application may henceforth refer to fluid, gas, or air flowing through the flow paths or channels of E-TESS module 100, but it should be noted that these terms may be used interchangeably herein and are intended to have the same meaning. Moreover any suitable fluid, such as air or CO₂, may be used to extract the heat out of E-TESS module 100. Additionally, some bricks are left out of the view in FIG. 1 to provide easier viewing.

FIG. 2 shows a side view of an embodiment of E-TESS module 100. The E-TESS module 100 comprises a large quantity of E-brick assemblies 102, arranged in a plurality of adjacent columns, which are physically and electrically interconnected in a serpentine fashion to form a contiguous circuit. The E-brick assemblies 102 may, in large part, be conductive only in the vertical direction (i.e., along the length of the columns), and electrically externally insulated in all other directions by the I-bricks, such that current follows the serpentine circuit (via the connected E-bricks) and does not arc between columns of E-brick assemblies 102, when there is a potential difference between the columns, e.g. in a case where different phases power are being run through adjacent columns.

Between columns there are flow paths or channels 208, through which air may flow (in the direction into or out of the page) in order to extract or harvest the thermal energy generated by the E-bricks to be used to a heat load. By flowing the air through the flow paths 208 the heat may be extracted from the E-TESS module 100 without having the air contact the E-bricks directly. This is especially useful because if the E-bricks comprise Cr₂O₃ and are exposed to the flowing air directly, then the Cr₂O₃ tends to volatilize, which erodes the brick electrical performance over time, and also produces a toxic gas, CrO₃, which must be kept below regulated levels and as low as possible.

Current may enter the E-TESS module 100, for example, through a cable (not shown) connected to the top left corner (from the perspective of FIG. 2), and may exit the E-TESS 100 through a cable (not shown) connected to the top right corner. In addition to the E-brick assemblies 102, there may be other bricks, such as double-wide bricks 202, thin bricks 204, and end connector bricks 206 used in the E-TESS module 100.

Double-wide bricks 202 provide horizontal stabilization between columns of E-brick assemblies 102, and structural integrity of the E-TESS module 100. Double-wide bricks 202 are insulated such that current can flow vertically within columns, but does not flow across them between columns. Double-wide bricks 202 may be thinner (i.e., have a lower height) than E-brick assemblies 102, because double-wide bricks 202 span the gaps 208 between columns, and therefore partially obstruct the airflow through the gaps 208. Double-wide bricks 202 may, for example, be half the height of an E-brick assembly 102.

Thin bricks 204 are single-wide, like an E-brick assembly 102, but thinner, i.e., have a lower height than an E-brick assembly 102. Thin bricks 204 may, for example, be half the height of an E-brick assembly 102. Thin bricks 204 may be used in conjunction with double-wide bricks 202 such that the height of the double-wide brick 202 and thin brick 204 stack is equal to the height of an E-brick assembly 102. Thin bricks 204 may also be used in place of a double-wide brick 202 to maintain even levels of bricks in situations where a double-wide brick 202 is not desirable in at least one column, e.g., due to its obstructing effect on airflow, but is desirable in another column of that level.

End connector bricks 206 connect columns of bricks together, both physically and electrically. End connector bricks 206 act as end caps to columns of bricks and contain within them E-bricks which may be of a different shape that those contained in the E-brick assemblies 102 to physically and electrically connect the E-Bricks from one column of E-brick assemblies 102 to an adjacent column of E-brick assemblies 102. Current may, for example, flow down one column of bricks, perform a “U-turn” through an end connector brick 206, and then flow up the adjacent column, until it reaches the next end connector brick 206, wherein it will perform another “U-turn”, and continue in that fashion. End connector bricks may have channels or cutouts though which air may flow. End connector bricks 206 may typically have a flat bottom (or top, depending on its orientation).

In some embodiments, a column of electrically conductive metal oxide material includes a plurality of stacked E-bricks, which may be mortared together. In other embodiments, a column of electrically conductive metal oxide material is a single contiguous structure.

FIG. 3 shows a specific embodiment of an electrically-conductive brick 300 (“E-brick”). As described above, E-bricks 300 may be configured to stack vertically with each other, which creates a part of a conductive circuit through which current and heat may flow. E-bricks 300 may be formed in many different shapes, including cross-sectional shapes of circles, rectangles, squares, or crosses, for example. FIG. 3 shows an example of a “dog bone” shaped E-brick. The E-brick 300 may have rounded or chamfered corners 302.

Referring also to FIG. 4, an E-brick 300 is configured to fit within an electrically insulating brick 400 (“I-brick”). I-brick 400 may have a hollow internal region 402, in which an E-brick 300 may fit. An E-brick assembly 102 may comprise an E-brick 300 inside of an I-brick 400. Based on the E-brick design, the exterior shape of the I-brick and the shape of the hollow internal region 402 may have differing shapes. Other bricks may also comprise an E-brick inside of an I-brick. The hollow 402 may extend through the height of the I-brick 400 so that the E-brick 300 may conductively connect with the E-bricks above and below.

Some I-brick embodiments may comprise multiple hollows, such as a double-length I-brick with two collinear hollows, each capable of housing an E-brick. The relative sizes of the E-brick 300 and I-brick 400 may be such that there are several millimeters of clearance between the exterior sides of the E-brick and the interior sides of the I-brick hollow. For example, there may be 1, 2, 5, 7, or 10 mm of clearance. The clearance allows thermal expansion to occur at different rates between the E-brick 300 and I-brick 400, due to material and temperature differences, and reduces friction damage between the E-brick 300 and I-brick 400. The rounded corners 302 also help reduce friction damage. Other bricks may have a hollow similar to hollow 402. I-bricks may comprise pin holes 404, in which pins or rods may be placed in order to align stacks of bricks. I-bricks 400 may be made in different shapes, both of the external sides and the internal hollow 402.

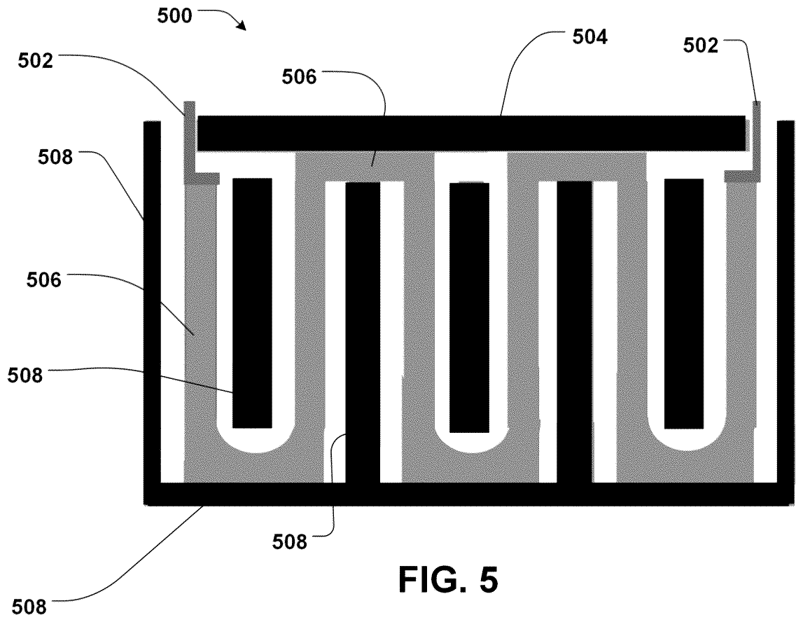

FIG. 5 shows a cross-sectional view of an embodiment of an electrically conductive brickwork module 500 according to the present disclosure. In this embodiment, electrodes 502, which are electrically connected by means of an external current source (not shown) pass through an insulating cover 504 into the electrically conductive brickwork module 500, thereby making contact with a serpentine circuit of E-bricks 506, which are resistively heated as current passes through them from the electrodes 502. The E-bricks 506 transfer heat to the thermal I-bricks 508, thereby providing an efficient thermal energy storage mechanism.

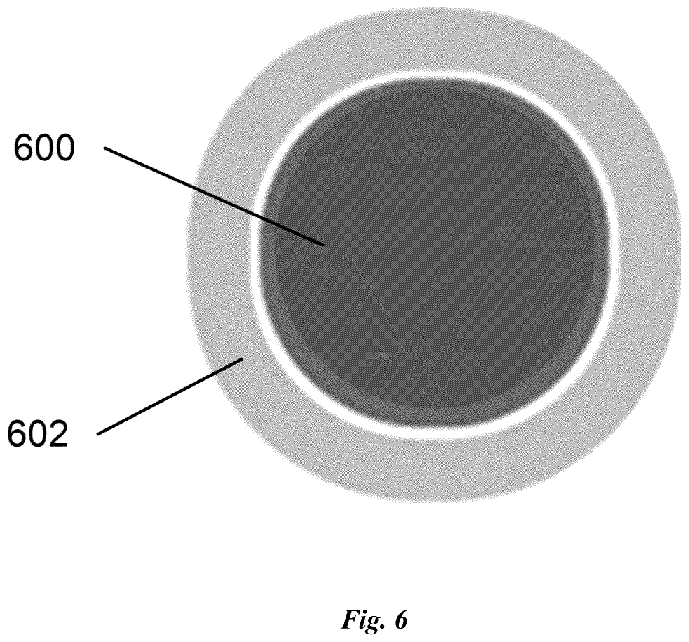

E-Bricks and I-Bricks may be provided in various shapes, such as cylinders. FIG. 6 shows an embodiment of a solid cylindrical E-Brick 600, within a hollow core region of circular I-Brick 602.

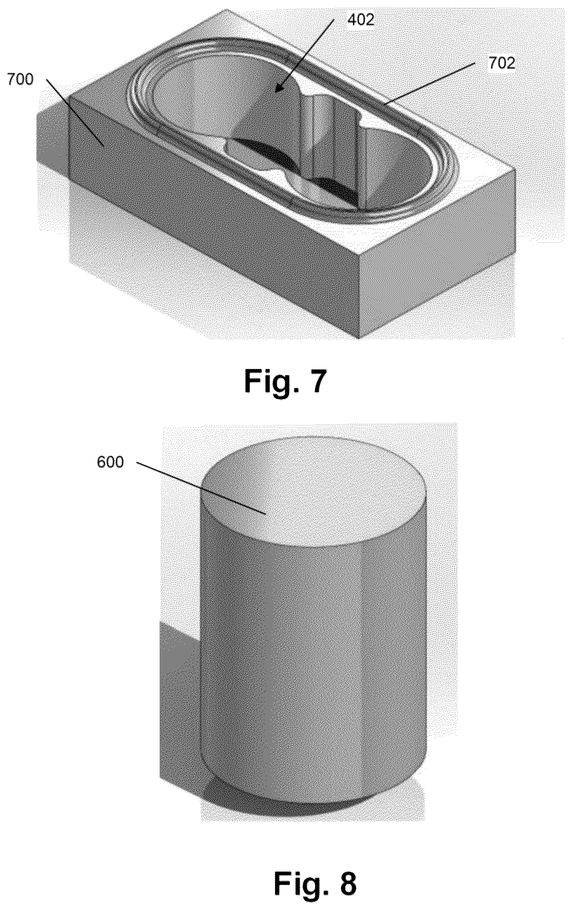

FIG. 7 shows an embodiment of a double-cylinder I-Brick 700, which has a hollow 402 configured to fit two solid cylindrical E-Bricks 600. The double-cylinder I-Brick 700 may also have a protruding ring 702 around the hollow 402.

The hollow interior region of the Double-cylinder I-Brick has an interior surface defined by the hollow interior region and the interior surface includes a first semi-circular section and a second semi-circular section opposite the first semi-circular section. Each of the first semi-circular section and the second semi-circular section are configured to receive an electrically conductive brick having a circular cross-sectional shape.

FIG. 8 shows a perspective view of an embodiment of a solid cylindrical E-Brick 600.

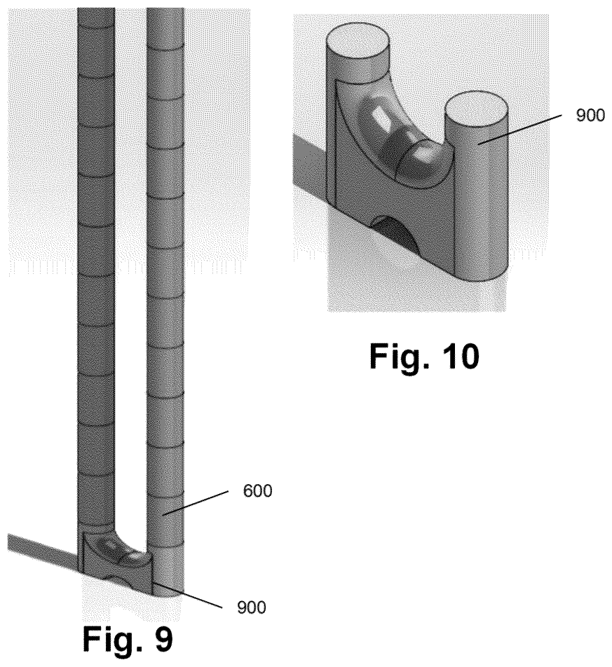

FIG. 9 shows an embodiment of two columns of cylindrical E-Bricks 600 which may be contained in a plurality of vertically stacked I-Bricks 700, FIG. 7. There is a double-cylinder end firebrick connector (a “cross-brick”) 900, which electrically connects the two columns, and has a flat base configured for standing.

FIG. 10 shows an individual view of cross-brick 900.

This disclosure describes how to modulate the electrical resistance along a column of electrically conductive bricks (“E-Bricks”) configured for use in, for example, electrically heated thermal energy storage systems (“E-TESS”). The E-bricks may be configured to stack vertically with each other, each stack or column creates a part of a conductive circuit through which current and heat may flow through the E-TESS. E-Bricks may also be referred to herein interchangeably as firebricks.

Electrodes are used to connect the E-TESS to an external power source (not and into the vertical stacks of E-Bricks, typically making a serpentine circuit from an input electrode to an output electrode, which electrodes may be located at the top of a first stack of E-Bricks and a last stack of E-Bricks in the E-TESS. It is desirable to reduce the temperature, to the extent possible, in the region of the electrodes to make the physical and electrical connections to the external source more feasible given the extremely high temperature of the E-TESS.

The present disclosure provides ways to modulate or change the electrical resistance along a column of E-Bricks and more particularly to modulating/changing the electrical resistance along a column of E-Bricks such that there is a temperature zoning along the column, from a hot zone in the middle and bottom of the column and a warm zone at the top of the column. In between the hot and warm zones there is a temperature transition zone.

This modulation may be managed by controlling the geometric ratio of the E-Brick material with E-Bricks in the hot zone, the warm zone, and the transition zone. For example, the widening of the E-Brick results in a lower electrical resistance and less heating of the E-Brick, while the smaller diameter E-Brick has an increased resistance and hence an increase in heating. Thus, by using E-Bricks with small cross-sectional profiles in the middle to lower portions of the E-Brick stack or column as compare to E-Bricks with wider cross-sectional profiles at the top of the stack the result is a warm zone at the top and a hot zone at the middle and bottom of the column with the transition zone (cross sectional profile transitioning from the smaller to larger) and having an intermediate temperature.

Another way to achieve the same result is to have E-Bricks with a constant cross-sectional profile along the entire column/stack, but have portions of the material in the central region of certain bricks removed to increase electrical resistance and heating due to less material being present. E-Bricks with less or no material removed from their central regions will have lower electrical resistance and lower temperatures being generated.

The following are several approaches to E-Brick structures for modulating the electrical resistance along a column/stack of electrically conductive bricks according to aspects of this disclosure.

E-Bricks with Center Material Removal

This disclosure includes designs for increasing the average resistance of an electrically heat brick while maintaining a larger footprint to decrease the average temperature gradient within an e-brick. Due to temperature, and mechanical limitations of materials used to connect one large stack of e-bricks to another, a geometric ratio of 4-6× needs to be achieved between the hot zone and the cool zone. By removing material from the middle of an E-Brick, the average volume for electricity to flow decreases, thus increasing electrical resistance (and temperature) and allowing for a large ratio. Below are some design geometries for increasing resistance while maintaining a large footprint. Some of the designs also provide a larger contract surface area for mortar contact. In each of the examples shown in FIGS. 1-9, the E-Bricks are substantially rectangular prism shaped. Some of the examples include interlocking features at either end but their central regions are rectangular prism shaped. However, this is not a requirement of this disclosure, as the designs of these examples could be applied to cylindrical, bow-tie or other shaped E-Bricks.

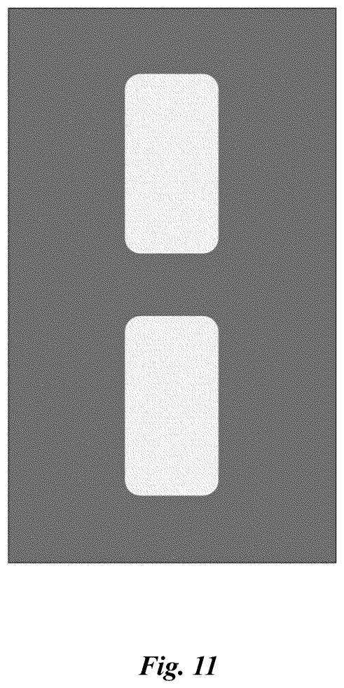

FIG. 11 shows a cross section (taken along the length/height) of a rectangular E-Brick having two vertically disposed hollow cavities (i.e. certain amount of material removed from the central region) that increase the electrical resistance of the E-Brick as compared to a solid rectangular E-Brick with the same dimensions. It should be noted that a single hollow cavity (see FIG. 5) could be used or three or more hollow cavities could be vertically disposed and it is based on the design requirements for the particular application.

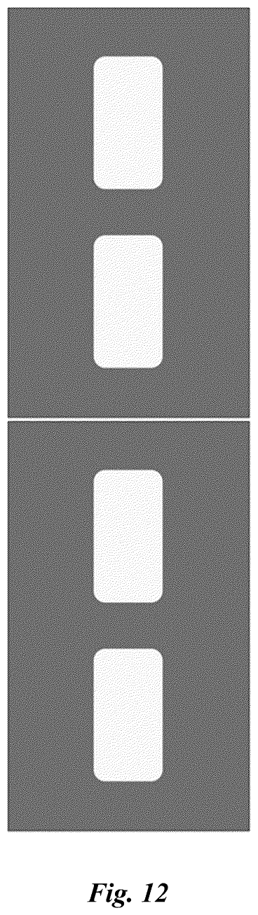

FIG. 12 shows the E-Brick design of FIG. 11 stacked one on top of the other to form a stack or column of E-Bricks. At the top of the stack or column (not shown) there would be an E-Brick with less or no material removed from the central region to reduce the electrical resistance and hence reduce the temperature of the E-Brick. There may be provided a transition E-Brick (not shown) with an amount of material present that is between the amount of material for the hot E-Bricks and the warm E-Bricks.

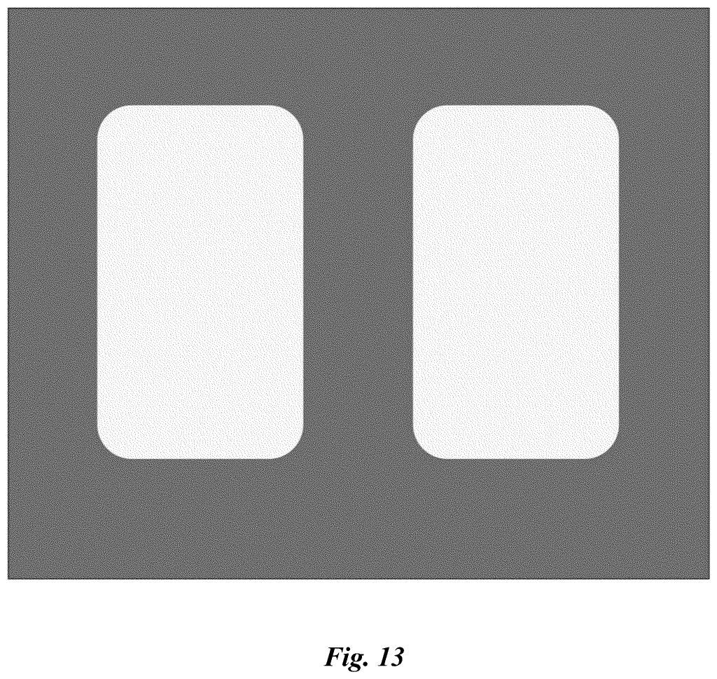

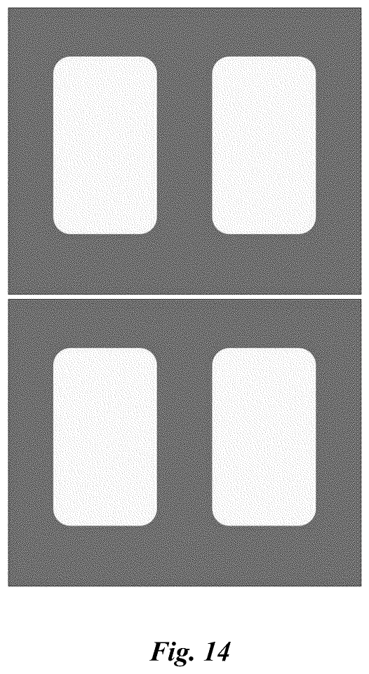

FIG. 13 is a cross section (taken along the length/height of a rectangular E-Brick) showing two horizontally disposed hollow cavities (i.e. certain amount of material removed from the central region) to increase the electrical resistance of the E-Brick compared to a solid rectangular E-Brick with the same dimensions. It should be noted that a single hollow cavity could be used or three or more hollow cavities could be horizontally disposed, depending on the design requirements of a particular application.

FIG. 14 shows the E-Brick design of FIG. 13 stacked one on top of the other to form a stack or column of E-Bricks. At the top of the stack or column (not shown) there would be an E-Brick with less or no material removed from the central region to reduce the electrical resistance and hence reduce the temperature of the E-Brick. There may be provided a transition E-Brick (not shown) with an amount of material present that is between the amount of material for the hot E-Bricks and the warm E-Bricks.

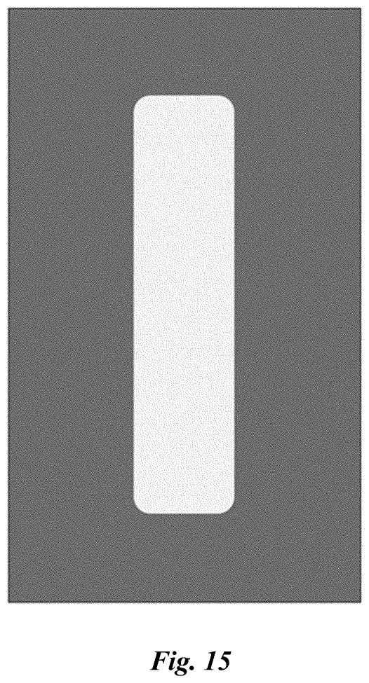

FIG. 15 is an E-Brick cross section (taken along the length/height of a rectangular E-Brick) showing a single, longer vertically disposed hollow cavity (i.e. certain amount of material removed from the central region) to increase the electrical resistance of the E-Brick compared to a solid rectangular E-Brick with the same dimensions.

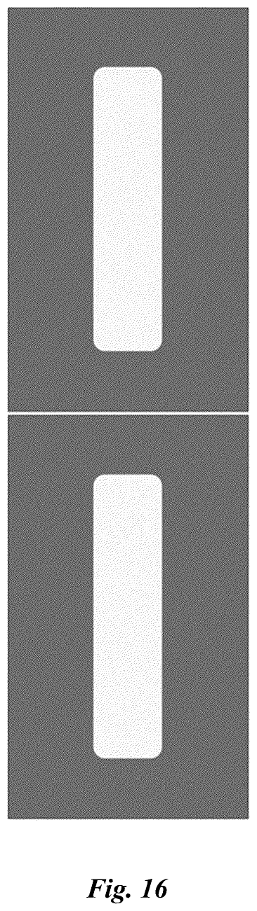

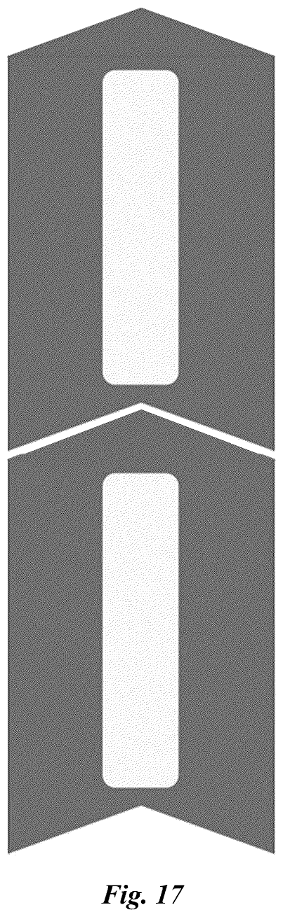

FIG. 16 shows the E-Brick design of FIG. 15 stacked one on top of the other to form a stack or column of E-Bricks. At the top of the stack or column (not shown) there would be an E-Brick with less or no material removed from the central region to reduce the electrical resistance and hence reduce the temperature of the E-Brick. There may be provided a transition E-Brick (not shown) with an amount of material present that is between the amount of material for the hot E-Bricks and the warm E-Bricks.

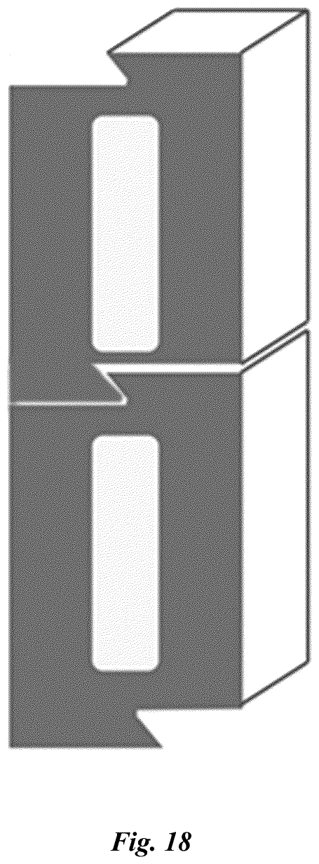

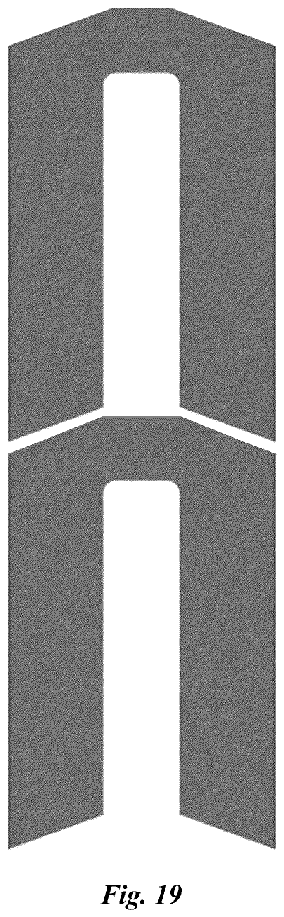

FIGS. 17-19 show several different E-Brick designs that may be stacked one on top of the other to form a stack or column of E-Bricks. In each case, there is a cross section (taken along the length/height of a rectangular E-Brick) which shows a single, longer vertically disposed hollow cavity (i.e. certain amount of material removed from the central region) to increase the electrical resistance of the E-Brick as compared to a solid rectangular E-Brick with the same dimensions. In these three designs, there are also shown complementary interlocking features at the top and bottom of each E-Brick to enable better connection between each E-Brick in the stack/column of E-Bricks.

As with the other designs, at the top of the stack or column (not shown) there would be an E-Brick with less or no material removed from the central region to reduce the electrical resistance and hence reduce the temperature of the E-Brick. There may be provided a transition E-Brick (not shown) with an amount of material present that is between the amount of material for the hot E-Bricks and the warm E-Bricks.

### Bow Tie E-Bricks

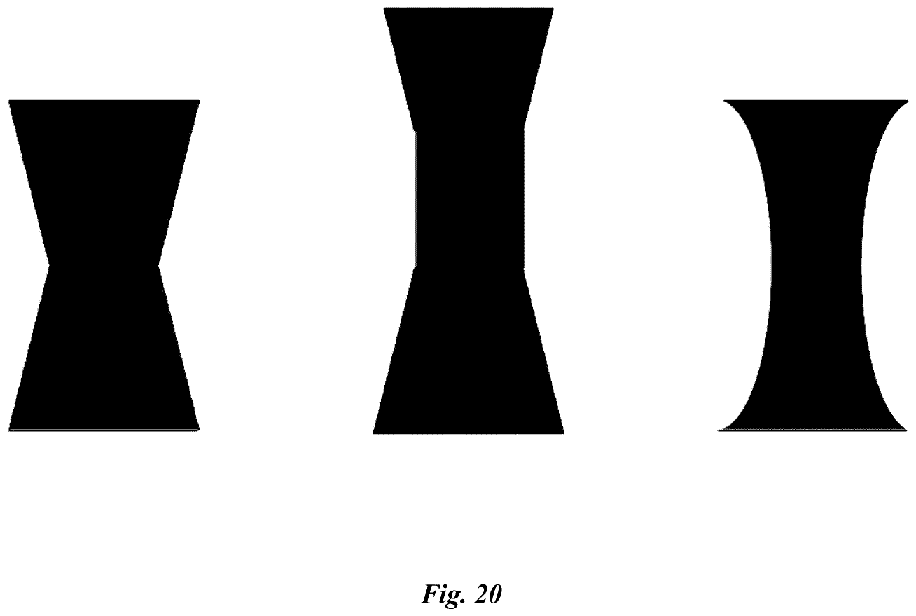

A “bow tie” shaped E-Brick widens towards the top and bottom edges and its thickness is at its minimum in the middle of the E-Brick. The widening brings more heat to the far-to-reach corners of the I-Brick and a thin middle section keeps the core temperatures manageable. FIG. 20 shows Bow Tie shaped E-Brick cross sections.

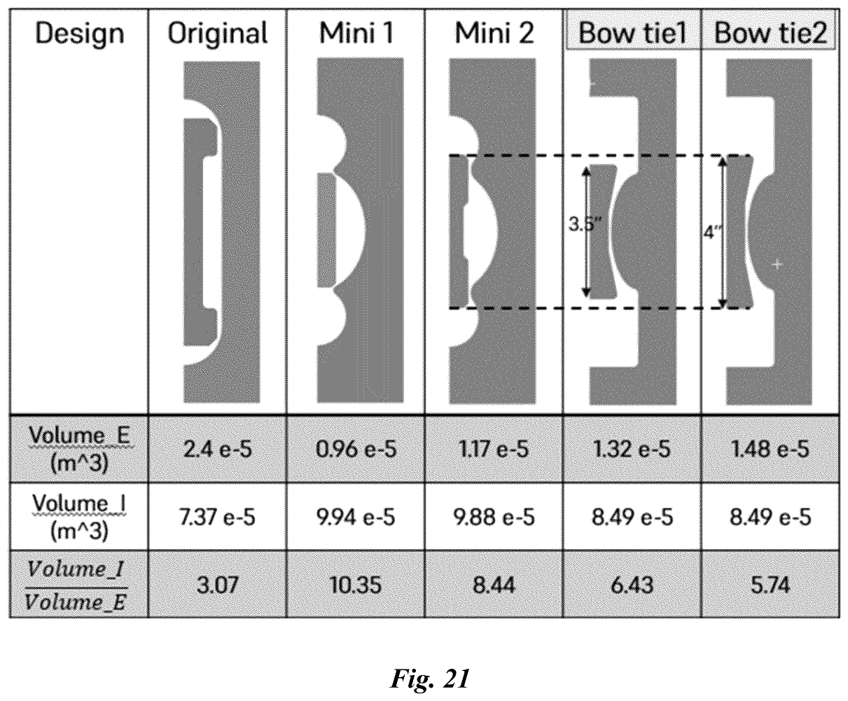

Referring to FIG. 21, there is a need for finding an E-Brick design that could work on a small scale for temperature zoning for hot zone. Assume that the “state of the art” nominal mini E-Brick shapes are Mini 1 and Mini 2 shown in FIG. 21. Compared to Mini land Mini 2, Bow Tie shapes have more manageable temperature gradients, and due to requiring less power density, the core temperature increase is better and heat is more evenly distributed within E-Brick and I-brick.

Compared to Mini 2 of FIG. 21, which is essentially a miniature version of the original dog-bone design (described in U.S. Publication No. US20250052516, which is hereby incorporated by reference for its disclosure of dog-bone designs), Bow Tie designs may be easier to manufacture.

Complementary I-Brick designs of the Bow Tie shapes may be easier to manufacture since they are much less complicated than those of Mini 1 and Mini 2.

As shown in FIG. 21, the Bow Tie E-Brick and its complementary I-Brick design have the closest volume ratio (volume_I/volume_E) to the original dog-bone design. Among the bow tie designs, bow tie 2 behaves better and has the closest ratio to the original design.

Bow Tie 2 in combination with periodically added prongs to I-Brick is an optimal design variation among the other combinations.

To complement the bow tie E-Brick shape, an I-Brick shape which looks like an inverted hourglass shape was designed and were considered in the models (FIG. 21). By nature of the I-Brick and bow tie design, the E-Brick is locked in-place and its movement within the I-Brick chamber is prohibited. FIG. 21 compares different designs, visually, volumetrically and by volume ratio. It should be noted that there is shown for ease of viewing only half of the E-Brick/I-Brick assembly and there would be a symmetrical second half included.

Temperature zoning between bottom and top sections of an E-Brick stack in an E-TESS may be achieved by using different materials and/or manipulating brick stack design. Specifically, for E-Brick volume across the E-TESS for the hot zone section, an E-Brick needs to be smaller for more concentrated power and to keep E-Bricks at a hotter temperature than the warm zone or the transition zone. Therefore, whichever bow-tie design is used for a given application, a smaller size bow-tie may be used throughout the hot zone and a larger bow-tie may be used for the warm and transition zones.

Having smaller E-Bricks has its own challenges. As shown by recent modeling efforts, as an E-Brick gets smaller, the power density (power/cross section area) increases, which pushes core E-Brick temperatures to hit its operating temperatures earlier than the original dog-bone design. Also, heightened power density elevates the temperature gradients in the smaller versions of E-Brick. The highest temperature gradients on the E-Brick happen on the top and bottom edges.

The bow-tie design has a widened top and bottom edges which helps with the peak temperature gradient. The recent electric charging model concludes that the best temperature gradient belongs to Bow-Tie 2, which is followed by Bow Tie 1 and Mini 2 compared to Mini 1.

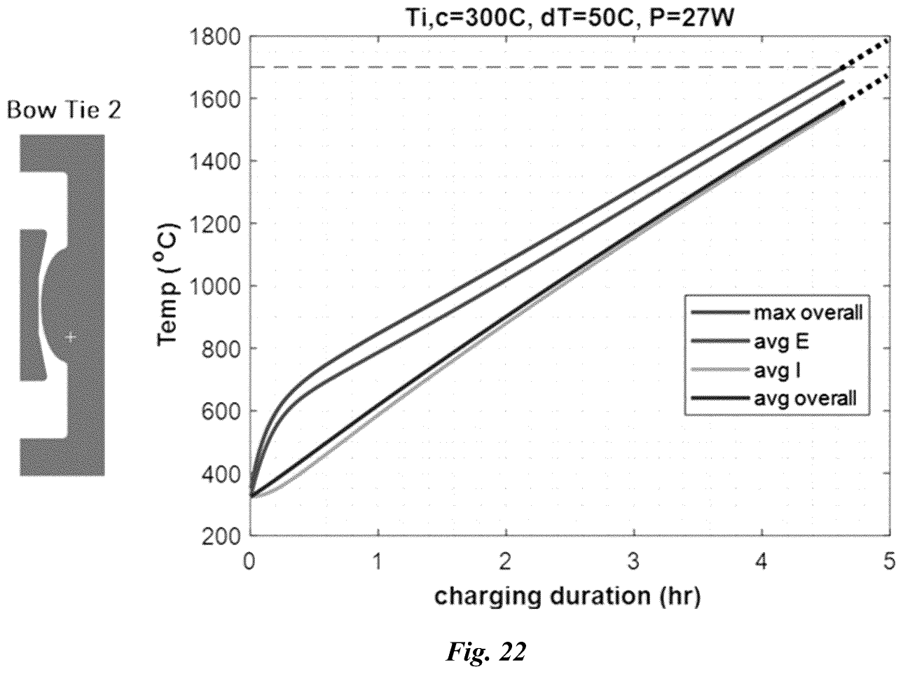

FIG. 22 shows electric charging model results with Bow Tie 2 design. The Bow Tie 2 design may be used to charge the system from 325° C. (average of 300° and 350° C.) to 1700° C. within 5 hours while keeping the core temperature below 1800° C.

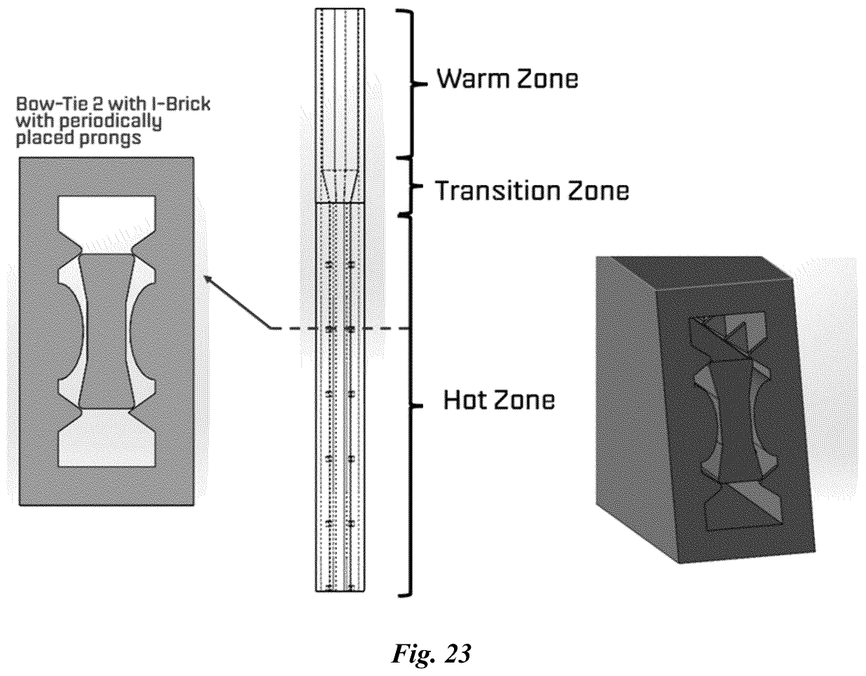

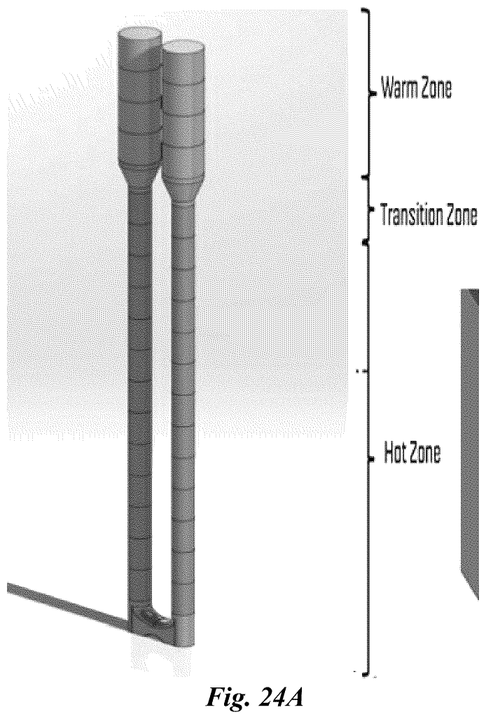

Referring to FIG. 23, when transitioning from the hot zone to the transition zone, the size of the bow tie E-Brick may be increased, and the bow tie size may be further increased for the warm zone. It should be noted that the outside footprint of the I-Brick may be maintained as the interior hollow region of the I-Brick is large enough to accommodate different E-Brick sizes.

### Cylindrical E-Bricks

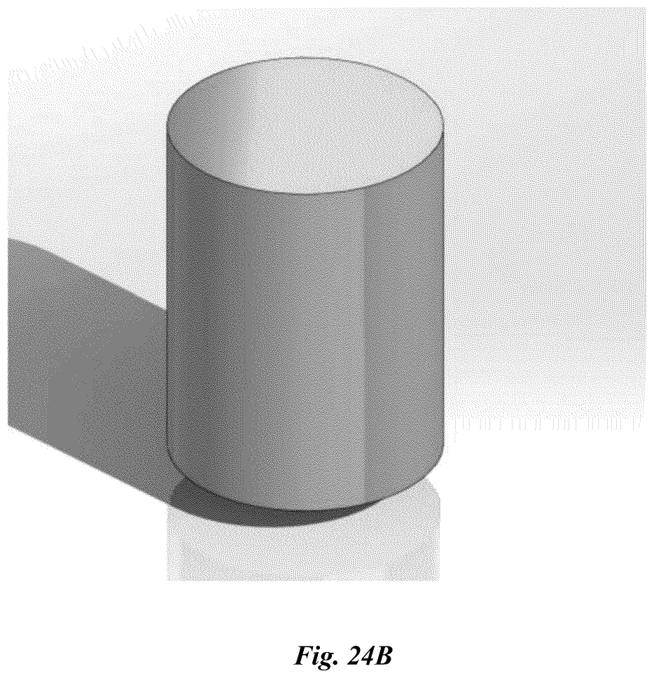

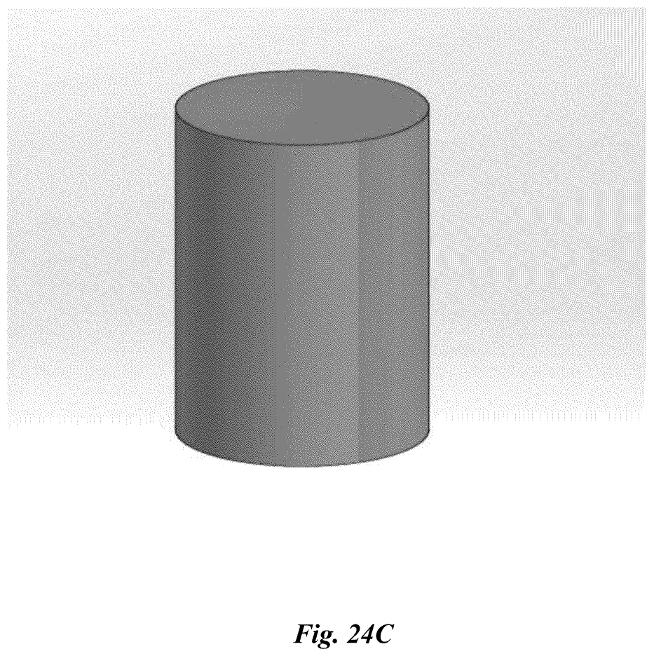

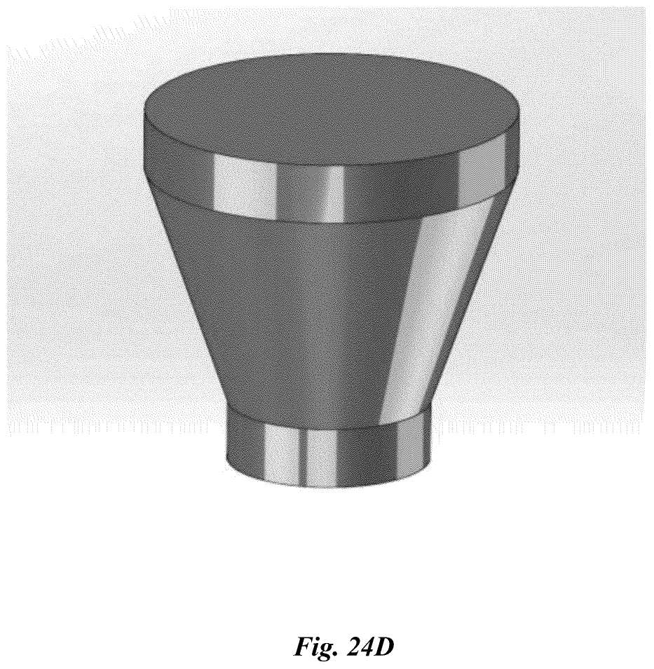

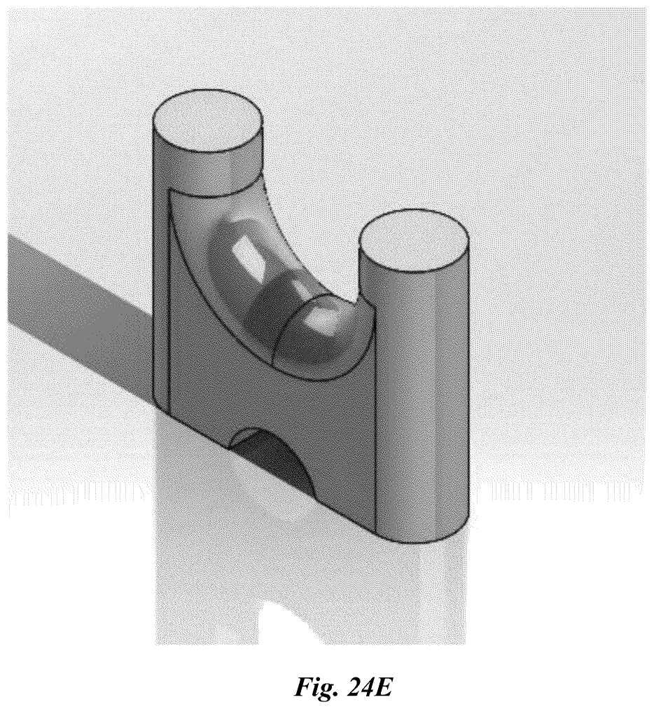

In other aspects, a column of cylindrically shaped E-Bricks having a greater/widening diameter towards the top of the column and a smaller diameter in the middle and bottom of the column is shown in FIGS. 24A-E. There is a transition zone from the middle to the top wherein the E-Brick shape is conical to transition from the smaller diameter E-Bricks in the middle and bottom of the column to the wider E-Bricks at the top of the column, where the external electrical connection (at ambient temperature) is made using electrical leads.

The widening of the E-Brick results in a lower electrical resistance and less heating of the E-Brick while the smaller diameter E-Brick has an increased resistance and hence an increase in heating, resulting in a warm zone at the top to the hot zone at the middle and bottom of the column with the transition zone in between having an intermediate temperature.

The cylindrical E-Brick in FIG. 24B has a larger diameter than the cylindrical E-Brick in FIG. 24C. The larger diameter E-Brick may be, for example, 1.5-2× greater than the diameter of the smaller E-Brick in FIG. 24C.

FIG. 24D shows an E-Brick having a greater diameter at its top compared to its bottom.

FIG. 24E shows a double-cylinder end firebrick connector (a “cross-brick”) that is configured to physically and electrically couple two columns of E-Bricks.

Various embodiments of the present invention may be characterized by the potential claims listed in the paragraphs following this paragraph (and before the actual claims provided at the end of this application). These potential claims form a part of the written description of this application. Accordingly, the subject matter of the following potential claims may be presented as actual claims in later proceedings involving this application or any application claiming priority based on this application. Inclusion of such potential claims should not be construed to mean that the actual claims do not cover the subject matter of the potential claims. Thus, a decision to not present these potential claims in later proceedings should not be construed as a donation of the subject matter to the public.

Without limitation, potential subject matter that may be claimed (prefaced with the letter “P” so as to avoid confusion with the actual claims presented below) includes:

P1. A column of electrically conductive bricks (E-Bricks) comprising:
a plurality of vertically stacked E-Bricks, each having a volume of material and each comprising a first end, a second end, and a length between the first and second ends;
wherein the column of vertically stacked E-Bricks comprises a top and a bottom, and wherein the plurality of vertically stacked E-Bricks is arranged such that the E-Bricks proximate to the bottom of the column have a lower average material volume than the E-Bricks proximate to the top of the column.

P2. The column of E-Bricks of potential claim P1, wherein at least one of the E-Bricks contains a hollow cavity between the first and second ends of the E-Brick.

P3. The column of E-Bricks according to any one potential claims P1-P2, wherein the plurality of E-Bricks in the column have the same cross-sectional area and wherein the E-Bricks proximate to the bottom of the column have each have a hollow cavity between the first and second ends of the E-Brick.

P4. The column of E-Bricks of potential claim P3, wherein each E-brick contains an interlocking feature on the first end and a complementary interlocking feature on the second end, and wherein the E-Bricks are interlocked along the column.

P5. The column of E-Bricks according to any one potential claims P1-P4, wherein each of the plurality of E-Bricks in the column has a constant volume of material throughout the E-Brick (i.e. there are no hollow cavities) and wherein the E-Bricks proximate to the bottom of the column have a smaller cross-sectional area and the E-Bricks proximate to the top of the column have a larger cross-sectional area.

P6. The column of E-Bricks of potential claim P5, wherein there is included as transitional E-Brick connected between the E-Bricks proximate to the bottom of the column and the E-bricks proximate to the top of the column and wherein the first end of the transitional E-Brick has a cross-sectional area equivalent to the larger cross-sectional area and the in the second end of the transitional E-Brick has a cross-sectional area equivalent to the smaller cross-sectional area.

P6. The column of E-Bricks according to any one potential claims P1-P5, wherein the plurality of E-Bricks are one of cylindrical in shape, bow tie shaped, or rectangular prism shaped.

P7: An electrically conductive brick (E-Brick), comprising:
a first end, a second end, and a length between the first and second ends;
at least one hollow cavity, having a cavity length, in the interior of the electrically conductive firebrick;
wherein the cavity length of the hollow cavity is less than the length between the first and second ends.

P8. The E-Bricks of potential claim P7, wherein the E-Brick is one of cylindrical in shape, bow tie shaped, or rectangular prism shaped.

P9. The E-Bricks according to any one of potential claims P7-P8, wherein the first end of the E-Brick includes an interlocking feature and the second end includes a complementary interlocking feature.

P10. A column of electrically conductive metal oxide material, the column comprising:
a first end;
a second end;
a body extending between the first end and the second end;
a first volume proximate the first end of the body; and
a second volume proximate the second end of the body;
wherein the first volume has a greater average cross-sectional area of electrically conductive metal oxide material, normal to a longitudinal axis of the body, than the second volume.

P11. The column of potential claim P10, wherein the body comprises a plurality of electrically conductive metal oxide bricks (E-Bricks), the first volume comprises one or more E-Bricks and the second volume comprises one or more E-Bricks.

P12. The column of potential claim P11, wherein the plurality E-Bricks are vertically stacked and the first end is at a top of the body and the second end is at a bottom of the body; and wherein each E-Brick has a volume of electrically conductive metal oxide material and each E-Brick comprises a first end, a second end, and a length between the first and second ends.

P13. The column of potential claim P12, wherein E-Bricks proximate the top of the body have a greater average cross-sectional area of electrically conductive metal oxide material than the E-Bricks proximate the bottom of the body.

P14. The column of potential claim P13, wherein at least one of the E-Bricks in the body contains a hollow cavity between the first and second ends of the E-Brick.

P15. The column of potential claim P14, wherein each of the plurality of E-Bricks in the body has the same cross-sectional area and wherein one or more E-Bricks proximate the bottom of the body have a hollow cavity between the first and second ends of the E-Bricks and one or more E-Bricks proximate the top of the body have a uniform amount of electrically conductive metal oxide material dispersed throughout the length of the E-Bricks.

P16. The column according to any one of potential claims P11-P15, wherein each of the plurality of E-Bricks in the body has a uniform amount of electrically conductive metal oxide dispersed throughout the volume of the E-Brick and wherein one or more E-Bricks proximate the bottom of the body have a first cross-sectional area and one or more E-Bricks proximate the top of the body have a second cross-sectional area, the first cross-sectional area being smaller than the second cross-sectional area.

P17. The column of potential claim P16, wherein one of the plurality of E-Bricks is a transitional E-Brick connected between the E-Bricks proximate the bottom of the body and the E-bricks proximate the top of the body and wherein the first end of the transitional E-Brick has a cross-sectional area equivalent to the first cross-sectional area and is in contact with one of the E-Brick proximate the bottom of the body and the second end of the transitional E-Brick has a cross-sectional area equivalent to the second cross-sectional area and is in contact with one of the E-Bricks proximate the top of the body.

P18. The column according to any one of potential claims P11-P17, wherein the plurality of E-Bricks are one of (i) cylindrical in shape, (ii) bow-tie shaped, or (iii) rectangular prism shaped.

P19. The column according to any one of potential claims P11-P18, wherein each E-brick contains an interlocking feature on the first end and a complementary interlocking feature on the second end, and wherein the E-Bricks are interlocked along the body.

P20. The column according to any one of potential claims P10-P19, wherein the body comprises a unitary structure of electrically conductive metal oxide material.

P21. The column of potential claim P20, wherein the first end is at a top of the body and the second end is at a bottom of the body, and wherein the first volume extends a first length from the top of the body toward the bottom of the body and the second volume extends a second length from proximate an end of the first volume to the bottom of the body.

P22. The column of potential claim P21, wherein the body includes a hollow cavity extending along at least a portion of the second length of the second volume.

P23. The column of potential claim P22, wherein the body, including along the first length and the second length, has the same cross-sectional area and wherein portions of the body proximate the bottom include the hollow cavity.

P24. The column of according to any one of potential claims P21-P23, wherein the body, has a uniform dispersion of electrically conductive metal oxide, including throughout the first volume and the second volume; and wherein along the first length the body has a first a cross-sectional area and along the second length the body has a second cross-sectional area, the first cross-sectional area being greater than the second cross-sectional area.

P25. The column according to potential claim P24, wherein there is included a transitional section between first length and the second length and a first end of the transitional section has a cross-sectional area equivalent to the first cross-sectional and a second end of the transitional section has a cross-sectional area equivalent to the second cross-sectional area.

P26. The column according to any one of potential claims P20-P25, wherein the body along the length is one of cylindrical in shape, bow tie shaped, or rectangular prism shaped.

The embodiments of the invention described above are intended to be merely exemplary; numerous variations and modifications will be apparent to those skilled in the art. All such variations and modifications are intended to be within the scope of the present invention as defined in any appended claims.

What is claimed is:

1. A column of electrically conductive metal oxide material, the column comprising:
a first end;
a second end;
a body extending between the first end and the second end;
a first volume proximate the first end of the body; and
a second volume proximate the second end of the body;
wherein the first volume has a greater average cross-sectional area of electrically conductive metal oxide material, normal to a longitudinal axis of the body, than the second volume.

2. The column of claim 1, wherein the body comprises a plurality of electrically conductive metal oxide bricks (E-Bricks), the first volume comprises one or more E-Bricks and the second volume comprises one or more E-Bricks.

3. The column of claim 2, wherein the plurality E-Bricks are vertically stacked and the first end is at a top of the body and the second end is at a bottom of the body; and wherein each E-Brick has a volume of electrically conductive metal oxide material and each E-Brick comprises a first end, a second end, and a length between the first and second ends.

4. The column of claim 3, wherein E-Bricks proximate the top of the body have a greater average cross-sectional area of electrically conductive metal oxide material than the E-Bricks proximate the bottom of the body.

5. The column of claim 4, wherein at least one of the E-Bricks in the body contains a hollow cavity between the first and second ends of the E-Brick.

6. The column of claim 5, wherein each of the plurality of E-Bricks in the body has the same cross-sectional area and wherein one or more E-Bricks proximate the bottom of the body have a hollow cavity between the first and second ends of the E-Bricks and one or more E-Bricks proximate the top of the body have a uniform amount of electrically conductive metal oxide material dispersed throughout the length of the E-Bricks.

7. The column of claim 2, wherein each of the plurality of E-Bricks in the body has a uniform amount of electrically conductive metal oxide dispersed throughout the volume of the E-Brick and wherein one or more E-Bricks proximate the bottom of the body have a first cross-sectional area and one or more E-Bricks proximate the top of the body have a second cross-sectional area, the first cross-sectional area being smaller than the second cross-sectional area.

8. The column of claim 7, wherein one of the plurality of E-Bricks is a transitional E-Brick connected between the E-Bricks proximate the bottom of the body and the E-bricks proximate the top of the body and wherein the first end of the transitional E-Brick has a cross-sectional area equivalent to the first cross-sectional area and is in contact with one of the E-Brick proximate the bottom of the body and the second end of the transitional E-Brick has a cross-sectional area equivalent to the second cross-sectional area and is in contact with one of the E-Bricks proximate the top of the body.

9. The column of claim 2, wherein the plurality of E-Bricks are one of (i) cylindrical in shape, (ii) bow-tie shaped, or (iii) rectangular prism shaped.

10. The column of claim 2, wherein each E-brick contains an interlocking feature on the first end and a complementary interlocking feature on the second end, and wherein the E-Bricks are interlocked along the body.

11. The column of claim 1, wherein the body comprises a unitary structure of electrically conductive metal oxide material.

12. The column of claim 11, wherein the first end is at a top of the body and the second end is at a bottom of the body, and wherein the first volume extends a first length from the top of the body toward the bottom of the body and the second volume extends a second length from proximate an end of the first volume to the bottom of the body.

13. The column of claim 12, wherein the body includes a hollow cavity extending along at least a portion of the second length of the second volume.

14. The column of claim 13, wherein the body, including along the first length and the second length, has the same cross-sectional area and wherein portions of the body proximate the bottom include the hollow cavity.

15. The column of claim 12, wherein the body, has a uniform dispersion of electrically conductive metal oxide, including throughout the first volume and the second volume; and wherein along the first length the body has a first cross-sectional area and along the second length the body has a second cross-sectional area, the first cross-sectional area being greater than the second cross-sectional area.

16. The column of claim 15, wherein there is included a transitional section between first length and the second length and a first end of the transitional section has a cross-sectional area equivalent to the first cross-sectional and a second end of the transitional section has a cross-sectional area equivalent to the second cross-sectional area.

17. The column of claim 11, wherein the body along the length is one of (i) cylindrical in shape, (ii) bow tie shaped, or (iii) rectangular prism shaped.
